(19) United States
(12) Patent Application Publication
(10) Pub. No.: US 2001/0038222 A1
(43) Pub. Date: Nov. 8, 2001

(54) Full forward couch unit

(76) Inventors: David E. Wallis, Dubuque, IA (US); Dennis A. Rice, Dubuque, IA (US)

Correspondence Address: David C. Brezina, Lee, Mann, Smith, McWilliams, Sweeney & Ohlson, P. O. Box 2786, Chicago, IL, 60690-2786, US

(21) Appl. No.: 09/777,193

(22) Filed: Feb. 2, 2001

Related U.S. Application Data
(60) Provisional application No. 60/179,966, filed on Feb. 3, 2000.

(51) Int. Cl. B60N 2/02

(52) U.S. Cl. 296/65.05; 297/337

(57) ABSTRACT

A couch frame for vans and recreational vehicles provides for secure mounting of the couch, with pivoting forwardly enabled by a pair of pivots at the front of opposite sides of the legs and with a pair of spring loaded, channel shaped latches linked by a crossbar so that they can be simultaneously released with actuation of a single handle.

### CLAIM OF PRIORITY

Priority is claimed based on application Ser. No. 60/179,966 filed Feb. 3, 2000.

### BACKGROUND OF INVENTION

1. Field of the Invention

A couch frame is particularly adapted to vans and recreational vehicles and provides for secure mounting of the couch, with pivoting forwardly enabled by a pair of pivots at the front of opposite sides of the legs, with a pair of spring loaded, channel shaped latches linked by a crossbar so that they can be simultaneously released with actuation of a single handle.

2. Description of Related Art

Some prior art shows a plurality of latches, but used with a first one latch for a seat base and a second latch for a seat back. These do not teach the coacting latches transversely spaced on the base of a couch, as taught in this invention.

Several patents disclose a variety of leg retraction mechanisms using complicated links and latches that are pulled directly or indirectly, as by cables, to disengage the leg retraction links or other leg connections, but do not teach the single handle actuation of a plurality of spaced latches, or latches of the advantageous configuration of the present latches.

A variety of patents show latches that work by capturing a pin or rod between movable latch plates, one latch plate having a “V” or “C” shaped mouth or notch, while the other rotating relative thereto to effectively close the mouth or notch.

### BRIEF DESCRIPTION OF THE INVENTION

The invention enables the user or operator to simultaneously release both sides of a fairly heavy and cumbersome mechanism with one hand while lifting with the other hand. The mechanism uses a structurally strong support frame to support a vehicle couch, but enables the frame and couch to pivot to a full forward position to provide increased floor clearance, while the floor mounted rail, pivot and lock release mechanism lies substantially flat to the floor.

### BRIEF DESCRIPTION OF THE DRAWINGS

FIG. 1 is a perspective view of the couch base in its open condition.

FIG. 2 is a side elevational view of the latch portion of the couch base in its locked condition.

FIG. 3 is a side elevational view of the couch base in its locked condition.

FIG. 4 is a side elevational view of the couch base in its open condition.

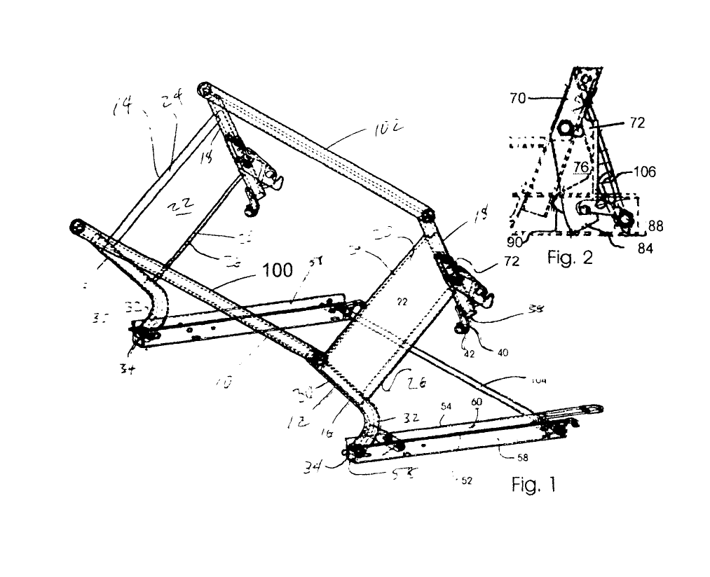

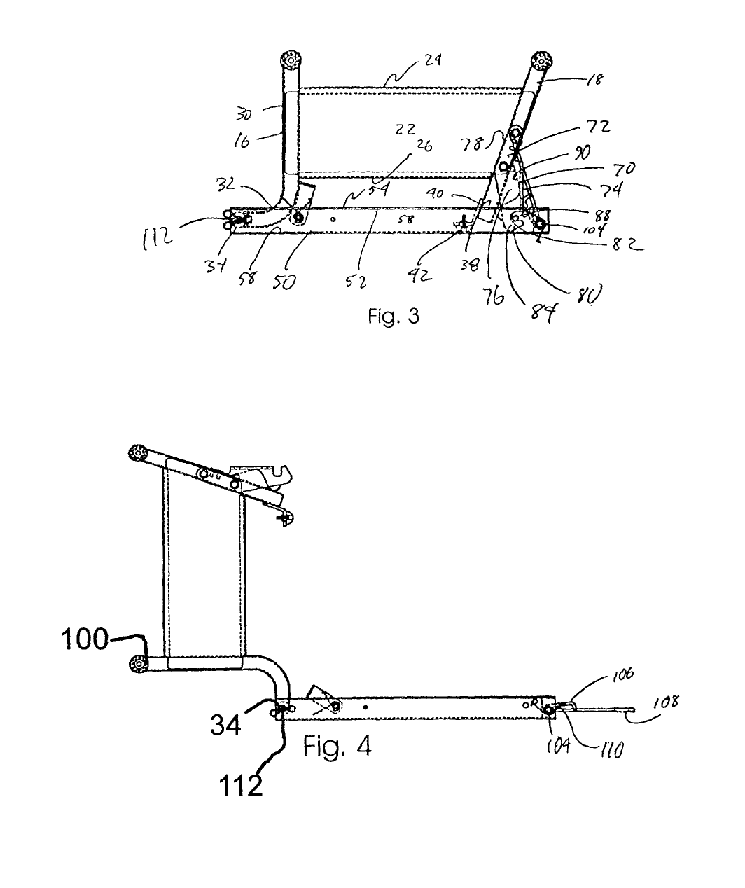

### DETAILED DESCRIPTION OF THE PREFERRED EMBODIMENT

The embodiment uses a couch frame 10 having a pair of leg units 12, 14 each of which has a curved front leg 16 and straight rear leg 18 joined by a parallelogram shaped cross piece 20 having a web 22 formed into channels or flanges at the top 24 and bottom 26 for strength.

Front legs 16 are curved having a downwardly dependent portion 30 and a lower forwardly curved portion 32 extending to a boss or cylindrical end 34 having a bore 36 that enables a pivoting connection.

Rear leg 18 is generally straight at its lower end 38 being fitted with a L-shaped bracket having a bumper or foot 42 on the lower flange.

Leg units 14, and particularly pivot 34, are mounted in floor channels 50. While generally referred to as channels 50, these, in fact, have a slightly modified “hat” section with outwardly turning flanges 52 and inwardly turning flanges 54. Upstanding from the floor web 56 is an outer wall 58 and an inner wall 60 from which flanges 52, 54 extend. Latch mechanism 70 has a latch member 72 formed in a channel shape with its rear web 74 joining left and right flanges 76, 78. Ends 80 are cut away to form slots 82 in hook ends 84 of each of the respective flanges 76, 78. Accordingly, each release mechanism 70 is provided with a pair of hooks 84. As each latch mechanism 70 is mounted on each rear leg 18, a total of four (4) hooks 84 retain the couch in position. Slot 82 engages pin 88 that spans walls 58, 60.

Hooks 84 are maintained in engagement against pin 88 by being biased rearwardly by spring 90.

Leg units 12, 14 are interconnected by a front transverse member 100 and rear transverse member 102. Floor channels are mechanically affixed to the floor of the vehicle. However, they are interconnected by a release control rod 104. Rod 104 extends in the manner of an axle through the two floor channels from the outboard walls 58 through the inboard walls 60 to the opposed outboard wall 58. Rod 104 rotates to engage a J-shaped pressure member 106 simultaneously with each of the webs 74 of the paired release members 70. This is accomplished through the manual movement of handle 108. Handle 108 is normally biased into a horizontal, floor contacting position by spring 110. Thus, swinging handle 108 forward around rod or axle 104 forces J-shaped member 106 to contact web 74 pressing mechanism 70 against spring 90 such that end 84, and particularly slot 82, becomes disengaged from pin 88. This permits the entire mechanism to pivot forwardly around boss 34, which is itself pinned using front pin 112.

Front leg 16 is advantageously formed with the downwardly depending portion 30 and lower curved portion 32 that leads to the pivot boss or cylindrical portion 34 in that this enables significant clearance between the front transverse member 100 and the vehicle floor as shown in FIG. 4, enabling clearance for upholstery mounting atop the frame and for the resting of the couch in a position where the center of gravity of the couch is shifted forward of the pivot 34, which assists in retaining the couch unit in its raised position.

The term “forward” in the context of the orientation of the couch is relative to its preferred mounting, that is as a forward facing seat in a van or recreational vehicle. Similarly, the terms rear and transverse are also relative. However, the principles of the mechanism could be applied, where appropriate, to side or rear facing seats, in particular environments.

While the present invention has been disclosed and described with reference to a single embodiment thereof, it will be apparent, as noted above that variations and modifications may be made therein. It is also noted that the present invention is independent of the machine being controlled, and is not limited to the control of couches. It is, thus, intended in the following claims to cover each variation and modification that falls within the true spirit and scope of the present invention.

We claim:

1. A couch frame for pivotally mounting a unit in vehicles comprising:
spaced support members, each having a front leg and a rear leg;
a pair of linearly extending and substantially parallel floor mounted channels, each having pivots at one end and a latch at the opposite said end;
said front legs being pivotally attached to said pivot ends and said rear legs being removably attached to said latch ends by spring loaded closed latches pivotally mounted at each said latch end;
said latches being linked by a crossbar so that they can be simultaneously released; and
a single handle movably attached to one of said latches whereby said latches can be opened by actuation of said handle.

2. The couch frame of claim 1 further comprising:
said latches being channel shaped and having flanges joined by a web, and having locking ends formed in said flanges, each of said locking ends being formed in a hook shape;
said floor mounted channels being formed with a web joining a wall;
said walls being interconnected at their latch end by a pin;
said pin receiving said hooks in a locked position.

3. The couch frame of claim 1 further comprising:
said front legs formed with a downwardly depending portion and lower curved portion;
said legs being connected by front and rear transverse members;
said lower curved portion leading to said pivot thereby enabling significant clearance between the front transverse member and the vehicle floor to enable clearance for upholstery mounting atop the frame and for the resting of the couch in a position where the center of gravity of the couch is shifted forward of the pivot and thereby assists in retaining the couch unit in its raised position.

4. The couch frame of claim 1 further comprising:
said crossbar being pivotally mounted on and spanning the space between said floor mounted channels so as to move between a rest position where the crossbar is adjacent the vehicle floor and a latch releasing position whereby the latches are depressed by the movement of said handle;
said latches being operably and disengageably linked to said crossbar by the engagement of a J shaped pressure member mounted on the crossbar against each latch channel whereby simultaneous depression and release of said latches is accomplished.

5. A couch frame for a vehicle for pivotally mounting a seating unit, comprising:
spaced leg members, each having a front leg and a rear leg;
floor mountable channels having pivots at a pivot end and a latch end opposite said pivot end;
spring loaded, channel shaped latches pivotally mounted at each latch end, having latch pivots and locking ends opposite the latch pivots;
said latches being operably and disengageably linked by a crossbar so that they can be simultaneously released with actuation of a single handle.

6. A couch frame for vans and recreational vehicles having a vehicle floor comprising:
horizontal frame members being supported by a pair of front legs and a pair of rear legs;
a pair of channels being mounted to the floor, each channel having a front and a rear;
said pair of front legs being pivotally mounted to said channels, one leg being mounted to the front of each channel;
a pair of spring loaded, channel shaped latches locking said rear legs to the rear of each channel;
said latches being linked by a crossbar so that they can be simultaneously released with actuation of a single handle.
